(19) United States
(12) Patent Application Publication
(10) Pub. No.: US 2012/0179612 A1
(43) Pub. Date: Jul. 12, 2012

(54) Method and apparatus for critical evaluation of products and services

(76) Inventor: Amod Ashok Dange, Los Angeles, CA (US)

(21) Appl. No.: 13/004,042

(22) Filed: Jan. 11, 2011

(51) Int. Cl. G06Q 99/00

(52) U.S. Cl. 705/317

(57) ABSTRACT

A product and service evaluation system having a center (10) for receiving submissions in respect of candidate products and services (12A, 12B) and an evaluation fee (13A, 13B) from product or service providers (11A, 11B). The center conducts a skills based test (15) to qualify professional evaluators (14A, 14B), and provides them with access (17A, 17B) to the candidate item and an evaluation apparatus (18). Product and service providers may apply to become evaluators. The center uses an assignment system (16) to assign products and services to evaluators in such a way that providers are never assigned their own products and services for evaluation. The evaluators submit evaluation data (19A, 19B) to the center and receive remuneration (20A, 20B) for each validated evaluation. The evaluator's remuneration is a portion of the evaluation fee paid by the provider. A product or service evaluation report (21A, 21B) is generated and shared with the product or service provider, who may choose to either have it published in a catalog (22), or to withhold it. The provider may improve and resubmit withheld items to the center. The center offers catalog access (23) to the potential consumers (24) of the product or service for an access fee (25).

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

The present invention relates to content translation, specifically to an improved method and system for evaluating products and services.

2. Prior Art

Offline, supposed experts affiliated with reputable publications such as Consumer Reports, Wired magazine, Zagat, etc. review products and services for the benefit of the masses. Online, product and service rating systems such as those found on Amazon, Yelp, Epinions, etc. provide a platform for consumers to review products and services for the benefit of future buyers. As the market is constantly flooded with new offerings, consumers find it hard to determine the quality of new and unknown products and services, and providers find it difficult to make their products and services discoverable, no matter how high their quality.

Publication US 2008/0195459 A1 by Stinski attempts to predict the commercial performance of a media product, regardless of its quality from a critical perspective. However, commercial success cannot be reliably predicted as it depends on many external factors often out of the control of producers and consumers. Additionally, commercial success is by no means the measure of the quality of a product or service.

U.S. Pat. No. 5,526,257 to Sam Lerner discloses a Product Evaluation System that generates an evaluation result that indicates the success and lack thereof of the product. This method also focuses solely on market performance of products with the objective of identifying items that will bring more profit for the merchants. It perpetuates products that are already popular, adding no real value to the consumer, as the intrinsic quality of the products is never addressed.

Publication US 2007/0282670 A1 by Rolf Repasi et al discloses a method of providing a rating for a software product based on weighted user feedback. This method fails to evaluate new and unknown products, as the feedback data is provided by consumers, who must essentially consume products of subpar quality to determine that they are indeed subpar.

Consumers cannot effectively filter products and services by quality using existing systems. Marketing campaigns often lead them to products and services that fail to meet their expectations. Too often, the products and services that are easiest to find also tend to be the most mediocre.

Just as providers cannot effectively demonstrate the quality of their products or services through advertising, advertising cannot guarantee that consumers will notice the high quality products and services being offered. Yet advertising plays a big part. Low quality products and services with a high marketing budget routinely outsell items without a marketing budget in the same marketplace.

Critically, providers themselves cannot provide objective quality-related data about their own products and services; only consumers can give credible ratings to benefit future consumers. Hence, for a new and unknown product or service to demonstrate its quality to potential users, some consumers must risk their time to try it. Due to this paradox, an enormous amount of high quality products and services remains undiscovered by their potential consumers, many of whom spend time trying products and services that they determine—after consuming them—to be of low quality.

### SUMMARY

In accordance with one embodiment, the method of evaluating products and services comprises a center where providers submit their candidate products and services and pay an evaluation fee. The center qualifies critical evaluators through a skills-based test, and provides them with access to the candidate product or service and a computer apparatus using which, they conduct critical evaluations.

In accordance with another embodiment, a computer apparatus enables qualified critical evaluators to evaluate candidate products and services efficiently. Multiple critical evaluations are combined to compute a score in respect of the candidate product or service, and the product and its evaluation report containing its evaluation score, are published in a catalog accessed by the potential buyers of the candidate items, whereas improvement suggestions from critical evaluators are made available to the candidate product or service providers.

Thus, the professional critical evaluation of all new products and services, the computation of an evaluation score, the generation of a critical evaluation report, the gathering and distribution of improvement suggestions, and the placement, in a catalog, of the product or service and partial or complete evaluation report and score, is a substantially more certain and economical way for product and service providers to reach potential consumers, as well it is a more certain way for consumers to find high quality products and services in a category of their choice.

### DRAWINGS—Figures

FIGS. 1A, 1B and 1C are a flowchart of the system utilized in the present invention.

FIG. 2 is an illustrative block diagram of the method in accordance with one embodiment.

FIG. 3 is an illustration of the apparatus in accordance with another embodiment.

### DRAWINGS—Referenced Numerals

10 center
11A, 11B product or service provider
12A, 12B candidate product or service
13A, 13B critical evaluation fee
14A, 14B critical evaluator
15 skills-based critical evaluator qualification test
16 assignment queue
17A, 17B access to candidate product or service
18 critical evaluation apparatus
19A, 19B critical evaluation data
20A, 20B critical evaluator remuneration
21A, 21B critical evaluation report
22 evaluated product and service catalog
23 product and service catalog access
24 product and service consumers
25 product and service catalog access fee
30 candidate product or service representation area
31 through 37 sliders
38, 39, 40 option buttons
41 database

### DETAILED DESCRIPTION

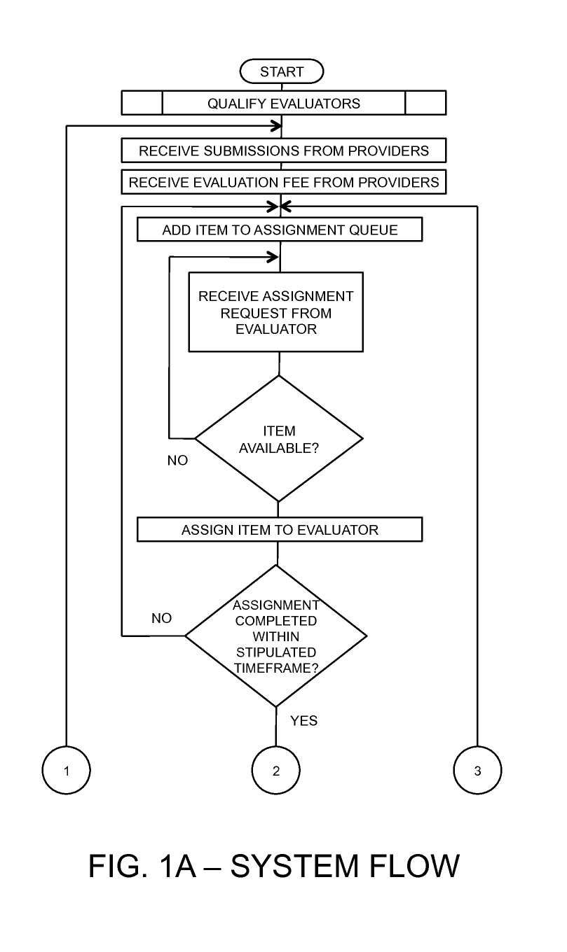

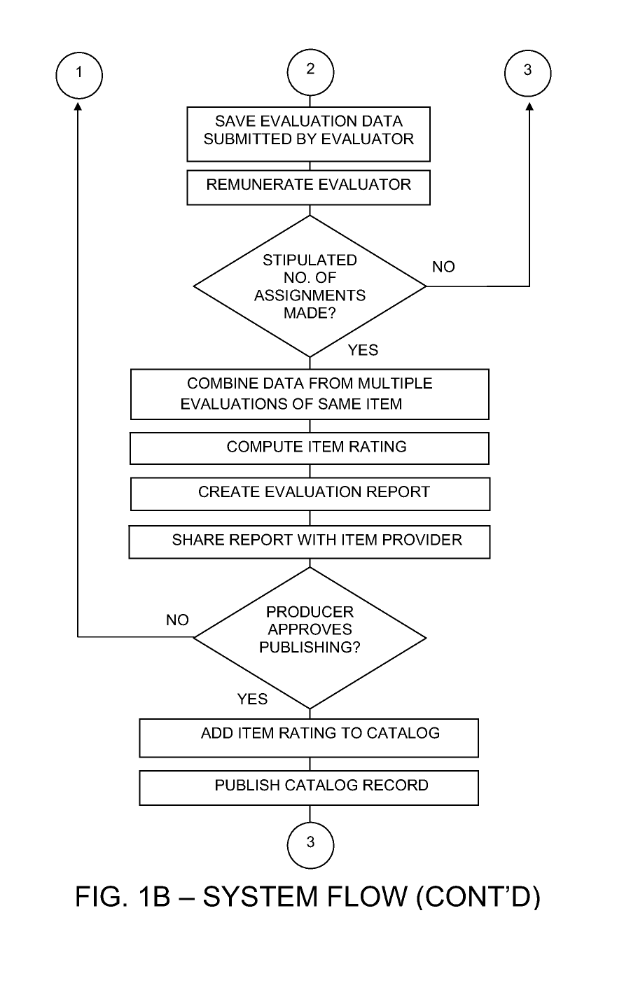

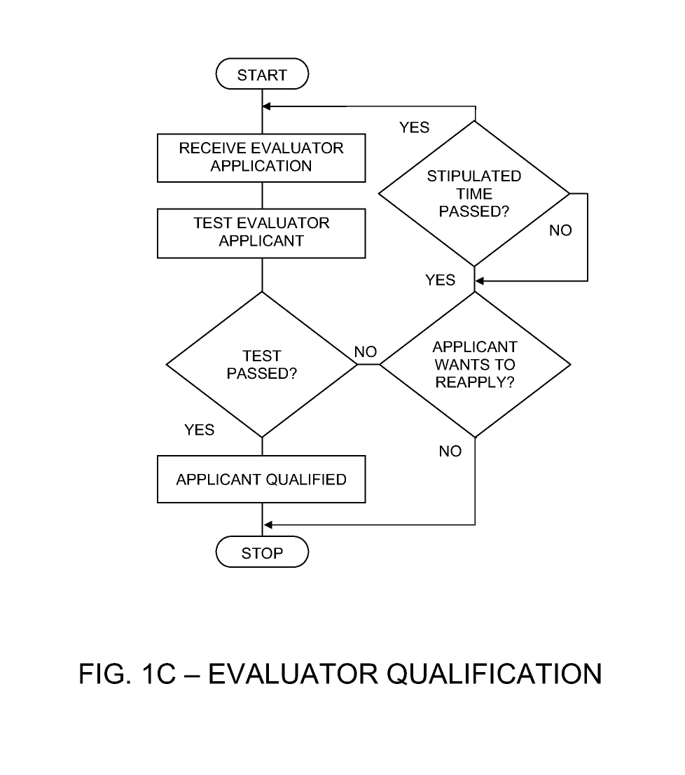

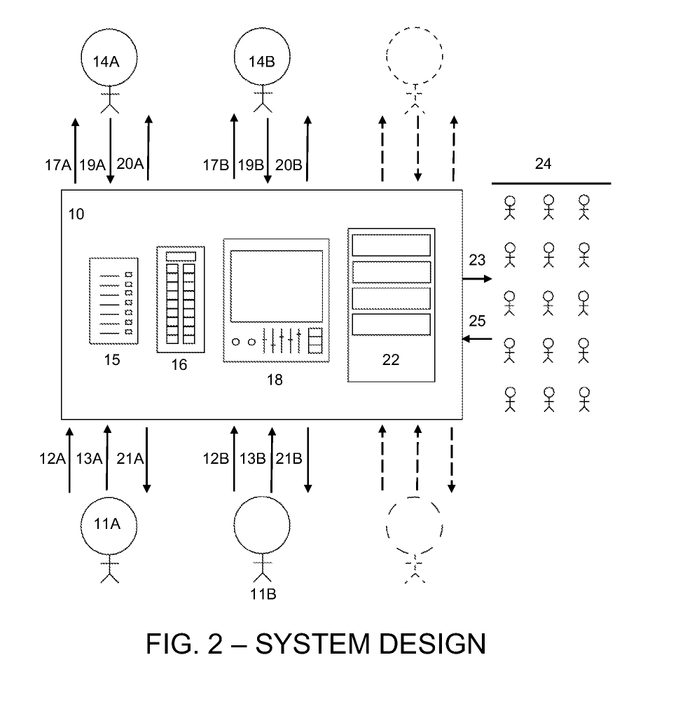

### FIGS. 1 and 2—First Embodiment

One embodiment of the invention is illustrated in FIG. 1A, FIG. 1B, FIG. 1C and FIG. 2. As shown in FIG. 2, a physical or web-based center 10 is provided where a product or service provider 11A, 11B can submit candidate product or service 12A, 12B, and pay an evaluation fee 13A, 13B. A plurality of evaluators 14A, 14B is are qualified through a skills-based test 15. Product or service providers themselves may apply to become evaluators. Candidate items received by the center are assigned to a predetermined number of evaluators in a queue 16 in such as way that those evaluators who are also providers will never be assigned their own items for critical evaluation. The evaluators get access 17A, 17B to the candidate item and a critical evaluation apparatus 18. Using the apparatus, they complete the evaluations assigned to them efficiently and consistently. Evaluators submit evaluation data 19A, 19B to the center within a specified timeframe and get remuneration 20A, 20B for each successful evaluation. The center pays the evaluators' remuneration out of the evaluation fee 13A, 13B paid to it by the product or service providers. Evaluation data received from a plurality of evaluators in relation to a particular item are combined to compute a product or service score and generate an evaluation report 21A, 21B. The report is shared with the product or service provider 11A, 11B. The provider may approve or withhold publishing in a catalog 22, of the product or service, and a report and score in respect of the product or service. Catalog access 23 is offered to potential product or service consumers 24 for a product or service catalog access fee 25. The product or service provider can use the critical evaluation report to make improvements in withheld items and resubmit those items through the same process.

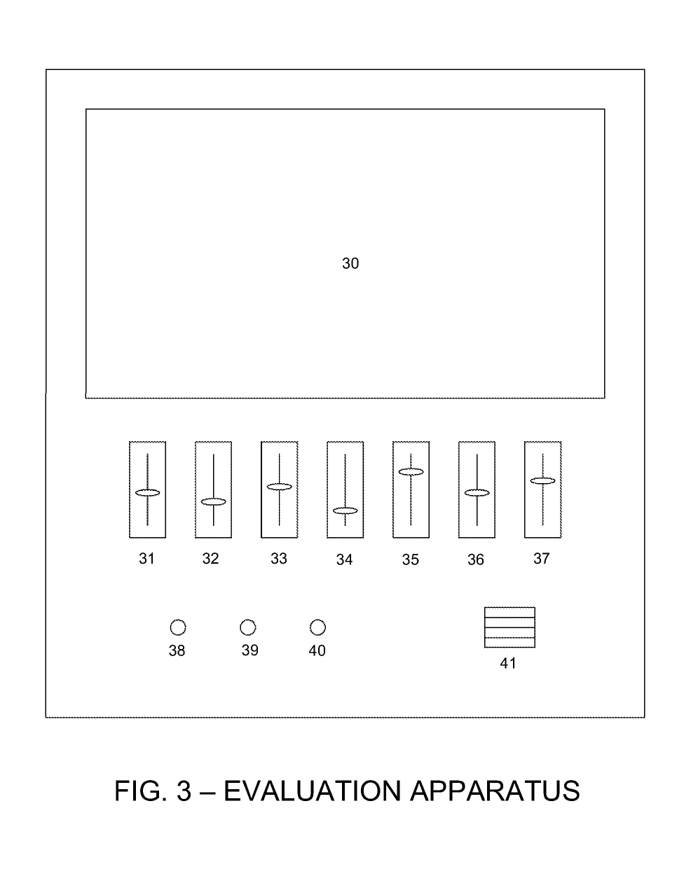

### FIG. 3—Additional Embodiments

Another embodiment of the invention is shown in FIG. 3, which is an illustration of the critical evaluation apparatus 18 (FIG. 2). The critical evaluation apparatus can be software or hardware, or a combination of the two. A qualified professional critical evaluator 14A, 14B (FIG. 2) tries the candidate product or service represented in area 30 and assigns values to a plurality of sliders 31 through 37. Each slider corresponds to a critical evaluation parameter based on the theories and principles widely accepted by those skilled in the category of the product or service. The evaluator records critical opinion regarding a parameter related to the product or service by choosing from a set of option buttons 38, 39, 40. When a value is attached to a parameter, it is stored in database 41.

### Advantages

From the description above, a number of advantages of some embodiments of my method of critical evaluation of products and services become evident:
a) The relevance of the product or service to the user's preferences is inconsequential if its quality is below par. My method evaluates the inherent quality or the product or service, which is of primary importance.
b) Unpaid consumers cannot be expected to perform parametric evaluations. Non-parametric ratings are subjective, and often merely reflect the consumer's preferences. My evaluation apparatus uses multiple objective parameters based on theories and principles widely accepted by those skilled in the category of the product or service.
c) In my method, a smaller number of evaluations can produce meaningful ratings, as the evaluations are parametric and performed by professionals. In free non-parametric user-rating based systems, even large numbers of ratings reflect little more than the popularity or a product or service, which may not necessarily be meaningful to consumers who seek quality.
d) My method remunerates critical evaluators, thus ensuring that all products and services that their providers want evaluated, are evaluated. In free user-rating based systems, products and services often remain unrated.
e) Providers finance the professional evaluation of their new and unknown products and services through a small and fixed evaluation fee. This removes from the consumers the burden of trying new and unknown products and services.
f) Critical evaluations are performed by skilled professionals, and are therefore more reliable than superficial user ratings.
g) The playing field in the market is leveled as filtering of products and services centers on quality, thus promoting merit over marketing.
h) Product and service providers save advertising costs and instead, pay a small fixed fee to have their products or services professionally evaluated, and their scores published in a searchable catalog.
i) Consumers have the ability to easily find high quality products and services from the vast amount of new and unknown products and services available at any given time.
j) Providers receive a thorough product or service evaluation report. They may choose not to distribute the product if it gets a low score and instead, use the report to make improvements in the product or service based on the suggestions received from the evaluators, and resubmit it the candidate product or service for evaluation through the same process. This results in an improvement in the overall quality of products and services in the marketplace.
k) Anyone possessing skills related to certain products or services has the opportunity to apply them to become a professional critical evaluator.
l) The playing field is leveled between independent product and service providers and powerful global corporations with multi-million dollar advertising budgets. Consumers break free from mainstream mediocrity, as quality trumps perception, enriching the lives of consumers with an infusion of new high quality products and services.

### Conclusion, Ramification and Scope

Accordingly, the reader will see that the various embodiments of the method and apparatus for critical evaluation of products and services will create a meritocracy in the marketplace on an unprecedented scale.

The efficiencies in today's globalized world have greatly reduced production and distribution cost barriers, but the resulting vast quantity of products and services poses a new noise barrier. The present invention successfully removes this barrier, providing a fair system in which providers have the opportunity to make their products and services discoverable simply on the basis of the inherent quality of the items, and nothing else.

Consumers as well face the problem of determining the intrinsic quality of new and unknown products and services in the absence of a true meritocracy. The present invention solves this problem and provides a reliable resource to consumers for finding new products and services that are more likely to satisfy their needs.

Although the description with reference to the drawings contains many specifics, these should not be construed as limiting the scope of the embodiments but as merely providing illustrations of a small number of the many possible specific embodiments, which can represent applications of the principles of the present invention. For example, depending on the type of product or service being evaluated, tools other than sliders and option buttons may be used to record critical evaluation parameter values. Another example of alternative embodiments is the number of critical evaluators that are assigned the same product or service. To obtain useful critical evaluation data sets while keeping the process economical for all the entities in the system, this number may be varied to suit different types of products and services.

### EXAMPLES

1. A digital camera manufacturer submits a camera model as a candidate item and pays an evaluation fee through a website. A plurality of qualified as critical evaluators receives the camera assigned to them by the center. The evaluators test the camera, use the evaluation apparatus to evaluate it, and provide useful feedback to the camera manufacturer. Upon successfully submitting the evaluation, each evaluator returns the camera and receives remuneration for the evaluation, paid for out of the evaluation fee paid by the camera manufacturer. The evaluation data is aggregated to compute an evaluation score for the camera model, and the manufacturer has the option to either publish this score to the catalog or withhold it to make product improvements and possibly resubmit the item. Consumers buy access to the catalog and choose cameras based on the scores listed in the catalog.
2. A musician offers guitar lessons. A plurality of qualified professional evaluators receives the assignment of critically evaluating the guitar lessons offered. They take the stipulated lessons and use the evaluation apparatus to make a critical evaluation of the quality of the lessons they received. Upon successfully submitting the evaluation, each critical evaluator receives a remuneration paid out of the evaluation fee paid by the musician. A score is computed by aggregating the evaluation data received from all the evaluators who were assigned the same candidate service. Upon receiving the evaluation report and score, the musician decides whether to publish it to the catalog, or to withhold it and make improvements and a possible resubmission. Potential guitar students buy access to the catalog and choose whom to take guitar lessons from based on the scores published in the catalog.
3. A restaurant owner submits the restaurant's menu as a candidate item and pays an evaluation fee through a website. A center assigns sets of specific items from the restaurant's menu to a plurality of qualified professional food critics. Each critical evaluator visits the restaurant and orders the exact items listed in her assignment. After the meal, they use the evaluation apparatus to evaluate the candidate items and record useful feedback to the restaurant owner. Upon successfully submitting the evaluation, each critical evaluator receives remuneration paid out of the evaluation fee paid by the restaurant owner. Item scores are computed by aggregating evaluation data received from all the evaluators who were assigned the candidate item. The restaurant owner decides to either publish the scored items to the catalog, or withhold publishing and use the feedback to make improvements, and possibly resubmit. Consumers buy access to the catalog, which helps them choose restaurants and decide what to order from which restaurant based on the restaurant scores and item scores published in the catalog.

These and various other changes and modifications obvious to one skilled in the category of the art to which the present invention pertains are deemed to be within the spirit, scope and contemplation of the present invention as further defined in the appended claims.

I claim:

1. A method of evaluating products and services, comprising:
(a) receiving candidate product or service from a provider;
(b) receiving an evaluation fee from said provider;
(c) qualifying a plurality of evaluators of said product or service on the basis of a skills test;
(d) assigning said candidate product or service to a set of said evaluators such that no evaluators are assigned products or services provided by themselves;
(e) capturing, by a computer, a record of said set of evaluators having consumed said candidate product or service;
(f) capturing, by a computer, evaluation data inputs from said set of evaluators, said evaluation data inputs comprising values assigned to a plurality of evaluation parameters, as determined by said set of evaluators;
(g) receiving said evaluation data from said set of evaluators;
(h) receiving improvement suggestions from said set of evaluators;
(i) computing a product or service score in respect of said product or service by combining said evaluation data received from said set of evaluators;
(j) disbursing portions of said evaluation fee to said set of evaluators;
(k) generating a product or service evaluation report in respect of said product or service received from said provider, said report comprising said evaluation data, said improvement suggestions, and said product or service score;
(l) sharing said product or service evaluation report with said provider;
(m) listing, upon approval from said provider, said product or service in a catalog;
(n) publishing, upon approval from said provider, said product or service evaluation report in respect of said candidate product or service, in said catalog;
(o) optionally, offering potential consumers access to said product or service catalog for a fee;
(p) optionally, offering said potential consumers said product or service for a price;
(q) optionally, sharing a portion of said price with said provider of said candidate product or service;
(r) receiving, optionally, resubmitted candidate product or service from said product or service provider, said provider having used said product or service evaluation report for improving said product or service.

2. The method of claim 1 wherein step (f) further comprises an a computer apparatus comprising:
(a) computer readable storage medium for storing computer implementable instructions for causing a computer to perform, display, or represent said candidate product or service;
(b) a computer readable storage medium for storing computer implementable instructions for causing a computer to assign values to a plurality of parameters relating to said evaluation of said candidate product or service.
